(19) United States
(12) Patent Application Publication
(10) Pub. No.: US 2025/0217167 A1
(43) Pub. Date: Jul. 3, 2025

(54) METHOD FOR CONFIRMING EVENT STATUS IN ROBOTIC PROCESS AUTOMATION THROUGH IMAGES

(71) Applicant: KINPO ELECTRONICS, INC., NEW TAIPEI CITY (TW)

(72) Inventors: Kuo-Chieh HSU, NEW TAIPEI CITY (TW); Kuo-Sen TSENG, NEW TAIPEI CITY (TW)

(21) Appl. No.: 18/605,852

(22) Filed: Mar. 15, 2024

(30) Foreign Application Priority Data
Dec. 27, 2023 (TW) 112151146

(51) Int. Cl. G06F 9/445; G06F 11/34; G06V 10/75

(52) U.S. Cl. CPC G06F 9/44568; G06F 11/3466; G06V 10/751

(57) ABSTRACT

A method for confirming event status in robotic process automation (RPA) through images is disclosed and includes following steps: initiating an RPA software in the OS; executing an event script by the RPA software; obtaining a pre-stored origin image associated with the event script, wherein the origin image includes an image of a geographic range on the displaying screen of the OS; automatically capturing a screenshot of same geographic range to obtain a current status image; comparing the current status image with the origin image; capturing a screenshot of same geographic range to obtain another current status image and comparing the another current status image with the origin image when the current status image is unmatched with the origin image; and, executing next step of the event script when the current status image matches with the origin image.

### BACKGROUND OF THE INVENTION

### Technical Field

The technical file relates to an RPA procedure, and specifically relates to a method for confirming the current status of an event in the RPA procedure.

### Description of Related Art

Robotic process automation (RPA) is an automatic robot procedure. Normally, the RPA procedure is utilized in the operation system (OS) of different electronic devices to assist the users to automatically execute routine and tedious tasks.

Specifically, when the RPA procedure is initiated, the user may operate the human-machine interface (such as the mouse or the keyboard, etc.) of the electronic device to perform a specific task, such as file converting or file downloading. Meanwhile, the RPA procedure stores the operation records, such as the tracing coordinate of the human-machine interface and the event being triggered by the human-machine interface, to generate an event script correspondingly. For example, the user can operate the mouse to move the mouse cursor to a specific column in the displaying screen of the OS, press the left button of the mouse on the specific column for the OS to pop out an information box, operate the keyboard to input an account and a password into the information box to login a specific folder, operate the mouse to move the mouse cursor to a specific position of the folder, and press the left button of the mouse on the specific position to trigger a button for downloading a file. The RPA procedure stores the above operation records made by the user through the mouse and the keyboard to be an event script corresponding to a file downloading procedure. Therefore, later when the RPA procedure executes the event script, the aforementioned file downloading procedure can be automatically implemented by the RPA procedure by simulating the operation made by the user.

Taking the file downloading procedure as an example, the RPA procedure can execute the event script to automatically download files; however, it is hard for the RPA procedure to automatically identify whether the file is downloaded completely and successfully. A part of the RPA procedures continuously checks the file size of the file being downloaded and determines that the file is downloaded completely when the file size stops increasing. Another part of the RPA procedures periodically checks a default folder or a specified directory and determines that the file is downloaded completely when an indicated file name exists in the folder or the directory. Yet another part of the RPA procedures waits for a fixed time period while executing the file downloading procedure and directly assumes that the file is downloaded completely after the fixed time period has passed. Yet another part of the RPA procedures periodically inquiries a file downloading API or a web service to retrieve the file downloading status and determines whether the file is downloaded completely based on the file downloading status.

The aforementioned approaches may assist the RPA procedures to confirm the file downloading progress; however, each of the approaches respectively has its drawbacks. For example, in the approach of checking the file size, it can only compare the file size with a pre-determined file size after the file is actually and completely downloaded; in the approach of checking the folder or the directory, it will cause uncertainty in the confirming progress due to the large variability of the file name. Furthermore, it has to travel through the whole directory and file structure while checking and it consumes longer processing time; in the approach of waiting for a fixed time period, it may cause the file downloading procedure to be interrupted if the fix time period is set too short or waste too many time for waiting if the fix time period is set too long; in the approach of inquiring the file downloading API or the web service, it needs to check whether the system provides the corresponding API or web service for monitoring the historical record of downloading, and it has to consume longer time to search for the keyword or filename of the file being downloaded, which causes uncertainty to the entire confirming procedure.

As mentioned above, in the application field of RPA, a naval technical solution is required to assist the RPA software to confirm the status of the current executing event, so as to increase the effectivity of the use of the RPA software.

### SUMMARY OF THE INVENTION

The disclosure is directed to a method for confirming event status in robotic process automation through images, which can accurately and effectively confirm the status of the event currently executed by the RPA software.

In one of the exemplary embodiments, the method of the present disclosure includes: initiating an RPA software; executing a pre-recorded event script by the RPA software; obtaining a pre-stored origin image associated with the event script, wherein the origin image includes a target image of a specific geographic range on a displaying screen; automatically capturing a screenshot of the geographic range to obtain a current status image by the RPA software; comparing the current status image with the origin image; capturing a screenshot of the geographic range again to obtain another current status image and re-comparing the another current status image with the origin image when the current status image is determined to be unmatched with the origin image; and, executing a next step of the event script by the RPA software when the current status image is determined to be matched with the origin image.

In comparison with related art, the present disclosure utilizes images of a specific geographic range on a displaying screen to determine the current status of the event currently executed by the RPA software, which may rapidly and accurately determine the execution progress of the event, thus increases the usage effectivity of the RPA software.

### BRIEF DESCRIPTION OF THE DRAWINGS

FIG. 1 is an origin image generating flowchart of a first embodiment according to the present disclosure.

FIG. 2 is a status confirming flowchart of a first embodiment according to the present disclosure.

FIG. 3A is a schematic diagram showing an origin image of a first embodiment according to the present disclosure.

FIG. 3B is a schematic diagram showing a current status image of a first embodiment according to the present disclosure.

FIG. 4 is an image comparison flowchart of a first embodiment according to the present disclosure.

FIG. 5 is a status confirming flowchart of a second embodiment according to the present disclosure.

FIG. 6A is a schematic diagram showing an origin image of a second embodiment according to the present disclosure.

FIG. 6B is a schematic diagram showing a first current status image of a second embodiment according to the present disclosure.

FIG. 6C is a schematic diagram showing a second current status image of a second embodiment according to the present disclosure.

FIG. 7A is a schematic diagram showing an origin image of a third embodiment according to the present disclosure.

FIG. 7B is a schematic diagram showing a current status image of a third embodiment according to the present disclosure.

### DETAILED DESCRIPTION OF THE INVENTION

The present disclosure discloses a method for confirming the event status in the robotic process automation (RPA) through images, which is applied in an electronic device that installs and runs an operation system (OS). In particularly, the method of the present disclosure is utilized to confirm the status of an event executed by the RPA software while the RPA software ran in the OS. Therefore, the integrity and the reliability of automated processes can be ensured and the chance of execution failures can be reduced.

The technical solution of the present disclosure is to, while the RPA software executes an event script, continuously capture images of a specific geographic range on the displaying screen of the OS, and analyze and compare the images of this geographic range to determine the current execution status of the event script. To do so, before performing the technical solution of the present disclosure, the user needs to first create the event script that is executable for the RPA software and capture an origin image that is corresponding to the event script being created. The origin image includes a target image of the geographic range on the displaying screen that indicates a specific status (such as download completed, download failed, or network error, etc.) of the event script. The geographic range is a display position that the specific status being displayed on the displaying screen, wherein the geographic range may be a rectangular region consisted of multiple coordinates on the displaying screen.

To create the event script, the user needs to operate the OS to complete the required procedure (such as a file downloading procedure) while the RPA software is initiated, so that the RPA software stores the operation content made by the user to generate an event script that is corresponding to this procedure. More specifically, the user needs to first initiate the RPA software in the OS, and then operates a human-machine interface (HMI) of the electronic device, such as the mouse, the keyboard, or the touch screen, etc. When receiving the operation from the HMI, the RPA software records the tracing coordinates of the HMI and the event being triggered by the HMI as the event script. For example, the event script can be an event script corresponding to the file downloading procedure or another event script corresponding to waiting and permitting a login request raised remotely.

Next, the user may set a script schedule of one or more event scripts for the RPA software. Therefore, the RPA software may automatically execute the corresponding event script(s) in accordance with the script schedule (such as date, time, and frequency, etc.), so as to automatically complete the user-required procedure(s) on the OS.

It should be mentioned that, to complete a full procedure, the user needs to execute multiple actions through the HMI. For example, the user needs to operate the mouse to open a specific website, operate the keyboard to input an account and a password into the specific website, operate the mouse to move the mouse cursor to a specific position of the website, and operate the mouse to click a file download button at the specific position, etc. In one embodiment, the RPA software may record the multiple actions mentioned above to be multiple steps of one event script. In another embodiment, the RPA software may respectively record the multiple actions mentioned above to be multiple event scripts and execute each of the multiple event scripts based on the script schedule.

To implement the method of the present disclosure, the user needs to capture a target image of a specific geographic range (which is a screenshot) on the displaying screen of the OS after a procedure is executed completely and stores the target image as an origin image corresponding to the event script of this procedure. For example, if the procedure is a file downloading procedure, the user needs to capture an image of a geographic range on the displaying screen that indicates a message of downloaded successfully after the file is downloaded completely and then stores the captured image to be the origin image. Therefore, the RPA software may utilize the origin image to automatically determine whether a file is completely downloaded while executing the event script corresponding to the file downloading procedure.

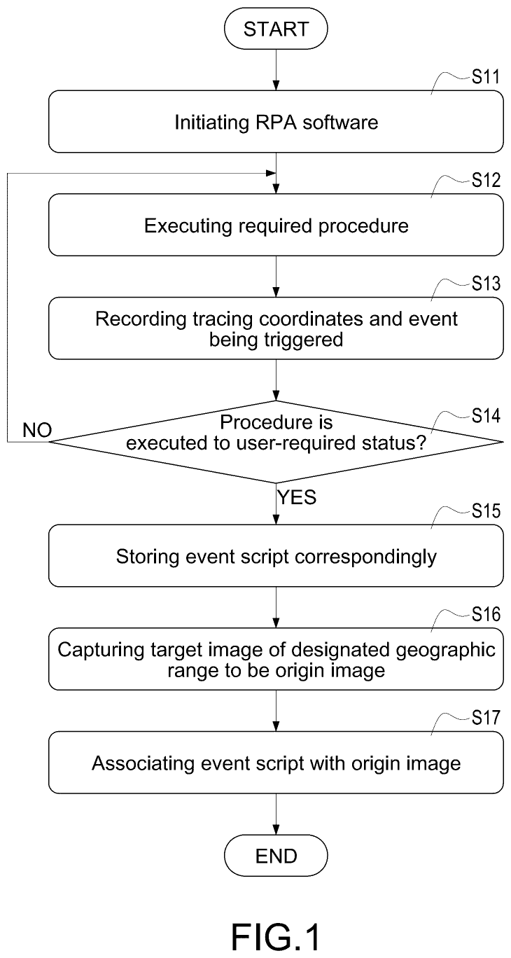

Please refer to FIG. 1, which is an origin image generating flowchart of a first embodiment according to the present disclosure. FIG. 1 interprets how the present disclosure generates the origin image required for determination before utilizing the RPA software to determine the execution status of the event script.

As disclosed in FIG. 1, first, the user initiates the RPA software on the OS of the electronic device (step S11), and then the user operates the HMI (such as the mouse or the keyboard) to execute a required procedure while the RPA software is initiated (step S12). When the user executes the procedure through the HMI, the RPA software automatically records the tracing coordinates of the HMI on the OS and the event being triggered by the HMI (step S13). Next, the user (manually), the OS (automatically), or the RPA software (automatically) determines whether the procedure is executed to a user-required status (step S14). In particular, the user-required status is a status that is given by the OS on the displaying screen through a specific message. Taking the file downloading procedure under a closed system as an example, the user-required status may be a status of file download completed; taking the file downloading procedure through website as an example, the user-required status may be a status of file download completed or network error; taking the remote desktop software login procedure as an example, the user-required status may be a status that the OS receives the login request raised remotely. However, the above descriptions are only few embodiments of the present disclosure, but not limited thereto.

If the determination made in step S14 is negative, the step S12 and the step S13 are re-executed to continuously execute the procedure through the HMI, and the RPA software continuously records the tracing coordinates and the event being triggered. If the determination made in step S14 is positive, the RPA software may generate and store an event script corresponding to this procedure based on the tracing coordinates and the event being triggered that are recorded in the step S13 (step S15). Meanwhile, the user may trigger the OS or the RPA software to capture the target image of a designated geographic range on the current displaying screen and store the captured target image to be the origin image (step S16). For example, if the procedure is the file downloading procedure, the user may command the OS or the RPA software to capture a target image of a geographic range on the current displaying screen that indicates the message of file download successfully and store this target image to be the origin image. In one embodiment, the user may designate the coordinate position of the geographic range on the displaying screen for the OS or the RPA software to capture the target image of the geographic range based on the designated coordinate position, so as to store the origin image.

After the step S16, the RPA software associates the event script stored in the step S15 with the origin image stored in the step S16 (step S17). Later when executing the event script, the RPA software may determine the execution status of the event script by using the origin image associated with the event script. It should be mentioned that same procedure may have multiple statuses that are required to be determined. For example, in the file downloading procedure through website, addition to determine whether the file is downloaded completely, it is also necessary to determine whether a network error occurs. To address the above issue, in the step S16, the OS or the RPA software may capture multiple target mages of multiple different geographic ranges according to user's setting, so as to generate multiple origin images respectively corresponding to different statuses of same procedure. In the step S17, the RPA software associates all the origin images stored in the step S16 with the event script stored in the step S15. Therefore, later when executing the event script, the RPA software may determine multiple execution statuses of the event script based on the multiple origin images.

After both the event script and the origin image(s) are stored completely, the OS may optionally turn the RPA software off, but not limited thereto.

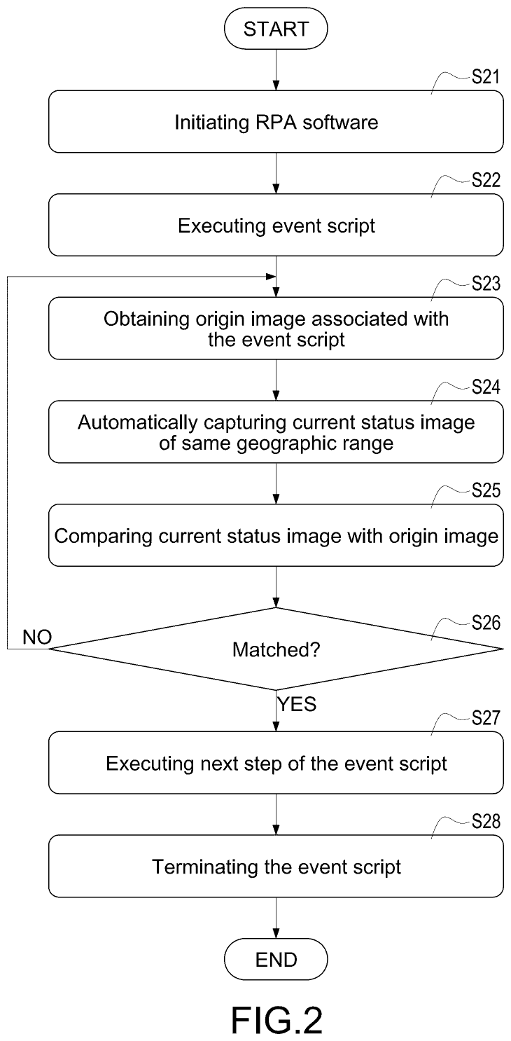

Please refer to FIG. 2, which is a status confirming flowchart of a first embodiment according to the present disclosure. As mentioned above, the method of the present disclosure is applied to an electronic device running an OS. First, the OS initiates the RPA software (step S21), then the RPA software executes a pre-recorded event script (step S22). In the present disclosure, the event script being executed is corresponding to a procedure required by the user, such as the file downloading procedure under a closed system, the file downloading procedure through website, and the remote desktop software login procedure, etc.

When the event script is executed to a default time point that is required to be confirmed, the RPA software reads the OS or a database to obtain the pre-stored origin image associated with the event script currently executed (step S23). As mentioned above, the origin image includes the target image of the specific geographic range on the displaying screen of the OS.

In one of the exemplary embodiments, the default time point can be, for example but not limited to, a time point after triggering a file download button in the file downloading procedure or a time point after launching a remote desktop software in the remote desktop software login procedure. In another embodiment, the RPA software may read the OS or the database immediately to obtain the origin image associated with the event script after executing the event script. However, the above description is only a part of the exemplary embodiments, but not limited thereto.

After the step S23, the RPA software automatically captures a screenshot of the same geographic range on the displaying screen of the OS to obtain the current status image (step S24). In the present disclosure, the geographic range where the RPA software captures the current status image is same as the geographic range where the RPA software captured the origin image. However, the origin image is captured after the procedure corresponding to the event script is completely executed, while the current status image is captured while the event script is executing (i.e., before the procedure is completely executed), so the content of the current status image may be different from that of the origin image. If the content of the current status image is different from that of the origin image, it means the event script has not yet executed to the user-required status (e.g., the file has not yet been downloaded completely).

After the step S24, the RPA software compares the current status image captured in the step S24 with the origin image obtained in the step S23 (step S25), so as to determine whether the event script is executed completely (i.e., whether the event script is executed to the user-required status). If the current status image is determined in the step S25 to be unmatched with the origin image (step S26), the RPA software re-executes the step S24 and the step S25 to re-capture the screenshot of same geographic range on the displaying screen to generate a new current status image, and then compares the new current status image with the obtained origin image. If the current status image is determined in the step S25 to be matched with the origin image (step S26), it means the event script has been executed to the user-required status (e.g., the file has been downloaded completely). Therefore, the RPA software may execute the next step of the event script (step S27). After all steps of the event script are completely executed, the RPA software can terminate the event script (step S28).

It should be mentioned that, in the step S24, the RPA software may re-capture the screenshot of the geographic range to generate the new current status image based on a default frequency. For example, the RPA software may re-capture the new current status image by every 0.5 second, every 1 second, or every 5 seconds until the new current status image is determined to be matched with the origin image. However, the above frequencies are only a part of the exemplary embodiments of the present disclosure, but not limited thereto.

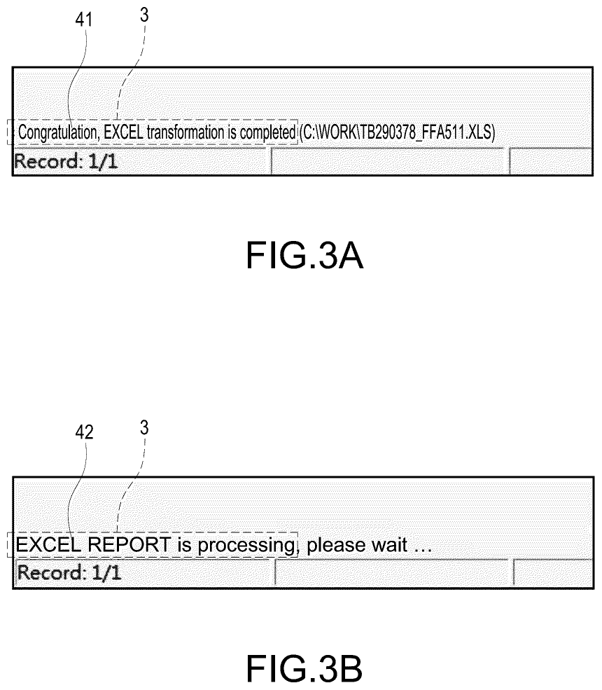

Please refer to FIG. 3A and FIG. 3B at the same time, wherein FIG. 3A is a schematic diagram showing an origin image of a first embodiment according to the present disclosure and FIG. 3B is a schematic diagram showing a current status image of a first embodiment according to the present disclosure.

FIG. 3A discloses an image of a part of the displaying screen of the OS. As mentioned above, the use needs to first operate the OS to complete the required procedure, so the OS displays the message indicating the finished procedure on a specific geographic range 3 of the displaying screen. In the present disclosure, the user may operate the OS to capture the target image of the geographic range 3 and stores the target image to be the origin image 41. In one of the exemplary embodiments, the user-required procedure is the file downloading procedure under a closed system, the origin image 41 is associated with the file downloading procedure under the closed system, and the origin image 41 includes the target image of the geographic range 3 on the displaying image indicating that the file is downloaded completely. In particularly, in the embodiment of FIG. 3A, the target image indicates “Congratulation, EXCEL transformation is completed”.

The FIG. 3B discloses an image of a part on the displaying screen of the OS same as that shown in FIG. 3A. The difference between FIG. 3A and FIG. 3B is that the image shown in FIG. 3A is an image after the procedure is completed, while the image shown in FIG. 3B is an image during the procedure is executing. In the step S23 of FIG. 2, the RPA software obtains currently executed event script (such as the script of the file downloading procedure under a closed system) to obtain a corresponding origin image 41. In the step S24 of FIG. 2, the RPA software continuously captures a screenshot of the geographic range 3 on the displaying screen of the OS to generate the current status image 42. In the step S25 of FIG. 2, the RPA software compares the current status image 42 with the origin image 41 to determine whether the file is downloaded completely. In the embodiment of FIG. 3B, the current status image 42 indicates “EXCEL REPORT is processing”, and it is apparently different from the content of the origin image 41. In this embodiment, the RPA software determines, in the step S26 of FIG. 2, that the current status image 42 is different from the origin 41, and then RPA software re-capture the screenshot of the geographic range 3 on the displaying screen to generate a new current status image 42 and again compares the new current status image 42 with the origin image 41 until the process is completed (i.e., the real-time captured current state image 42 matches the pre-stored original image 41).

As mentioned above, the content of the origin image 41 and the content of the current status image 42 are both captured from same geographic range 3 on the displaying screen, so the content of the origin image 41 and the content of the current status image 42 share same position and same size. In the present disclosure, the RPA software respectively retrieves pixels of the origin image 41 and pixels of the current status image 42 and determines whether the current status image 42 is matched with the origin image 41 based on the difference of the pixels.

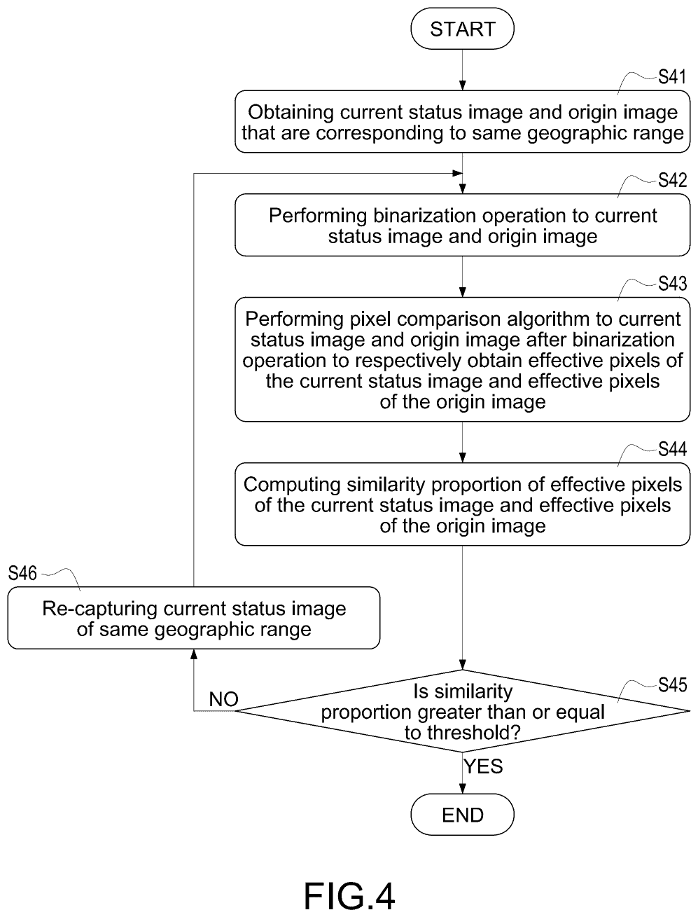

Please refer to FIG. 4, which is an image comparison flowchart of a first embodiment according to the present disclosure. As shown in FIG. 4, when comparing, the RPA software respectively obtains the current status image and the origin image that are corresponding to same geographic range (step S41), and then respectively performs a binarization operation to the current status image and the origin image (step S42). Next, the RPA software respectively performs a pixel comparison algorithm to both of the current status image and the origin image after the binarization operation to respectively obtain effective pixels of the current status image and effective pixels of the origin image (step S43). Next, the RPA software computes a similarity proportion of the current status image and the origin image based on the effective pixels of the current status image and the effective pixels of the origin image (step S44), and then determines whether the current status image is matched with the origin image in accordance with the similarity proportion.

The aforementioned binarization operation and the pixel comparison algorithm are common technical solution in the image computation field, detailed description is omitted here.

In one embodiment, when computing the similarity proportion, the RPA software divides the effective pixels of the current status image by the effective pixels of the origin image to obtain a calculation result, and then multiplies the calculation result by 100% to obtain the similarity proportion. Also, the RPA software determines whether the similarity proportion is greater than or equal to a default threshold (such as 90%) to determine whether the current status image matches with the origin image (step S45). If determining that the current status image is unmatched with the origin image (i.e., the similarity proportion is less than the threshold), the RPA software re-captures the screenshot of same geographic range on the displaying screen to generate a new current status image (step S46), and the RPA software re-executes the step S42 though the step S44 based on the new current status image to determine whether the new current status image is matched with the origin image. If determining that the current status image is matched with the origin image, it means that the event script is proceeding to a user-required stage (such as the file is downloaded completely), so the RPA software may execute the next step of the event script, terminate the event script, or execute the next event script, according to user's setting.

In the aforementioned embodiment, the user may set one geographic range for one procedure, capture the screenshot of this geographic range and store the captured image to be the origin image associated with this procedure after the procedure is completed, and the RPA software continuously capture the screenshot of this geographic range to real-time generate the current status image while executing the event script of this procedure. When comparing, the RPA software only compare the current status image of this geographic range with the origin image of this geographic range. However, emergencies may occur when the RPA software executes the event script. For example, when executing the event script corresponding to the file downloading procedure through website, network error may occur. To address this problem, in another embodiment, the user may set multiple geographic ranges for one procedure, and respectively capture a screenshot of each geographic range and store each captured image as different origin image associated with this procedure after the procedure is completed. Therefore, addition to determine whether the procedure is executed completely through the images, the RPA software may also determine whether an error occurs during the execution of the procedure.

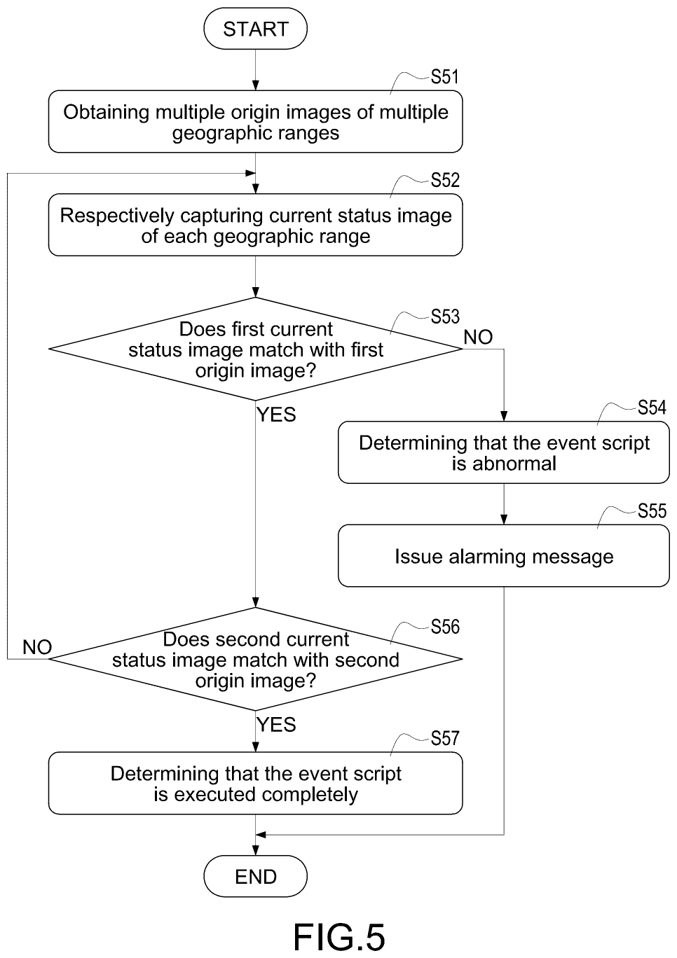

Please refer to FIG. 5, which is a status confirming flowchart of a second embodiment according to the present disclosure. As shown in FIG. 5, when executing an event script to a specific time point (such as operating the mouse to trigger a file download button), the RPA software reads the OS or the database to obtain multiple origin images associated with the event script (step S51). For the sake of understanding, the following description takes a first origin image and a second origin image associated with the event script as an example. In the embodiment, the first origin image has a first target image of a first geographic range on the displaying image of the OS, the second origin image has a second target image of a second geographic range on the displaying image of the OS, and the second geographic range is different from the first geographic range.

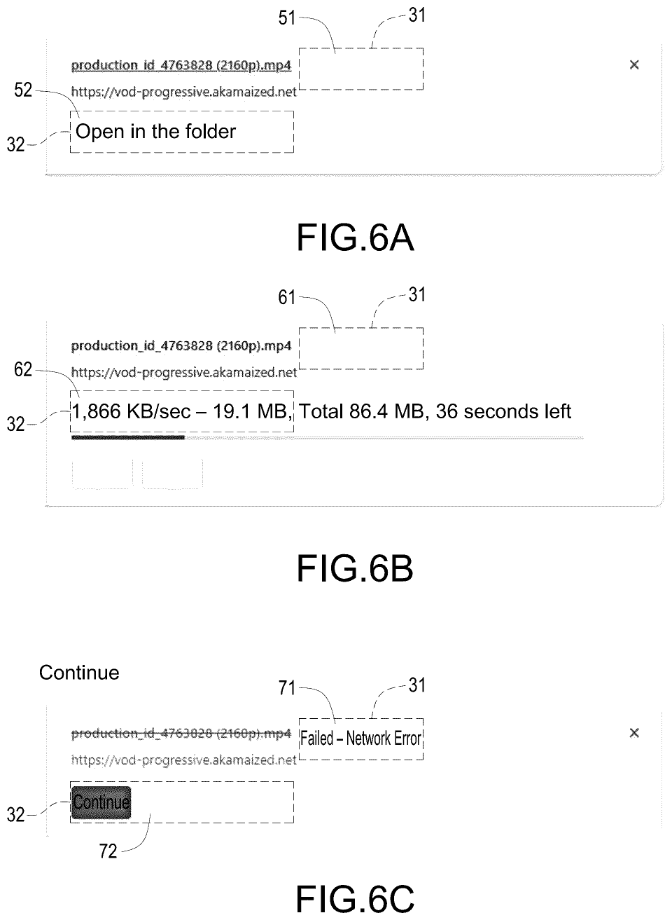

Please refer to FIG. 6A at the same time, wherein FIG. 6A is a schematic diagram showing an origin image of a second embodiment according to the present disclosure. FIG. 6A discloses an image of a part of the displaying screen of the OS. In the embodiment, a first status (such as download failed, or network error) of the procedure may be shown on the first geographic range 31 of the displaying screen and a second status (such as download completed or a storing position of the downloaded file) of the procedure may be shown on the second geographic range 32 of the displaying screen. Therefore, before utilizing the RPA software to execute the event script corresponding to this procedure, the user needs to first operate the OS to complete this procedure and respectively capture the screenshot of the first geographic range 31 and the screenshot of the second geographic range 32 after the procedure is completed to respectively store a first origin image 51 and a second origin image 52. In the embodiment, the content of the first origin image 51 indicates that the procedure is proceeding normally (i.e., a blank image), the RPA software utilizes the first origin image 51 to determine whether an error occurs to the current-executed event script. In the embodiment, the content of the second origin image 52 indicates the storing position of the downloaded file, the RPA software utilizes the second origin image 52 to determine whether the current event script is executed completely (i.e., whether the file is downloaded completely or whether the event script is executed to the user-required stage).

Please refer back to FIG. 5. After the step S51, the RPA software captures the screenshots of multiple geographic ranges associated with the event script in real-time to generate multiple current status images (step S52). For the sake of understanding, the following description takes the RPA software respectively capturing the screenshot of the first geographic range 31 to generate a first current status image and capturing the screenshot of the second geographic range 32 to generate a second current status image (i.e., the first current status image 61 and the second current status image 62 as shown in FIG. 6B) as an example, but not limited thereto.

After the step S52, the RPA software compares the first current status image 61 corresponding to the first geographic range 31 with the first origin image 51 corresponding to the first geographic range 31, and determine whether the first current status image 61 is matched with the first origin image 51 (step S53). A shown in FIG. 6A, the first origin image 51 is utilized to indicate that the procedure is proceeding normally (i.e. no abnormal message is shown). Therefore, in the embodiment of FIG. 5, the RPA software compares the second current status image 62 corresponding to the second geographic range 32 with the second origin image 52 corresponding to the second geographic range 32 and determines whether the second current status image 63 is matched with the second origin image 52 (step S56) only when the first current status image 61 matches with the first origin image 51.

If the first current status image 61 is determined, in the step S53, to be unmatched with the first origin image 51, the RPA software may determine that the execution of the event script is abnormal (step S54) and issue an alarming message (step S55). In the technical solution of the present disclosure, the RPA software continuously captures the first current status image 61 according to a preset frequency and compares the first current status image 61 with the first origin image 51 and issues the alarming message immediately when the comparing result shows that the first current status image 61 is unmatched with the first origin image 51. Therefore, the user may receive the alarming message and exclude the abnormal situation right after an error occurs (such as network error), so that the execution efficiency of the RPA software may be further improved.

If the second current status image 62 is determined, in the step S56, to be unmatched with the second origin image 52, the RPA software re-executes the step S52 though the step S56, i.e., respectively re-captures a new first current status image 61 and a new second current status image 62 from the first geographic range 31 and the second geographic range 32 on the displaying screen, re-compares the first current status image 61 and the first origin image 51, and re-compares the second current status image 62 with the second origin image 52. If the second current status image 62 is determined, in the step S56, to be matched with the second origin image 52, the RPA software may determine that the event script is executed completely (step S57).

Please refer to FIG. 6B and FIG. 6C at the same time, wherein FIG. 6B is a schematic diagram showing a first current status image of a second embodiment according to the present disclosure and FIG. 6C is a schematic diagram showing a second current status image of a second embodiment according to the present disclosure. FIG. 6B and FIG. 6C disclose the embodiment that the RPA software performs the file downloading procedure through website. As shown in FIG. 6B, the first current status image 61 includes the image of the first geographic range 31 on the displaying screen and the second current status image 62 includes the image of the second geographic range 32 on the displaying screen.

In this embodiment, the RPA software first compares the first current status image 61 with the first origin image 51. Because the first current status image 61 matches with the first origin image 51 as shown in FIG. 6A (i.e., is a blank image without indicating network error), the RPA software then compares the second current status image 62 with the second origin image 52. In this case, because the second current status image 62 is unmatched with the second origin image 52 (i.e., the second current status image 62 does not indicate that the file is downloaded completely), the RPA software determines that the current event script is not yet completely executed. In the meantime, the RPA software re-capture the screenshots of both of the first geographic range 31 and the second geographic range 32 to generate a new first current status image and a new second current status image (such as the first current status image 71 and the second current status image 72 shown in FIG. 6C).

As shown in FIG. 6C, the first current status image 71 (which is newly captured) includes the image of the first geographic range 31 on the displaying screen, the second current status image 72 (which is newly captured) includes the image of the geographic range 32 on the displaying screen, but the content of the first current status image 71 may be different from that of the first current status image 61 and the content of the second current status image 72 may be different from that of the second current status image 62 due to the advancement of the file download time.

In the embodiment, the RPA software first compares the first current status image 71 with the first origin image 51. In the embodiment, the first current status image 71 is unmatched with the first origin image 51 as shown in FIG. 6A (i.e., the first current status image 71 is not the blank image representing the network without abnormality), so the RPA software directly confirms that an error occurs to the event script (a network error in this embodiment) and immediately issues the alarming message. In the embodiment, the RPA software can omit comparing the second current status image 72 with the second origin image 52 to save system resource.

In the embodiment of FIG. 3A and FIG. 3B, the RPA software implements the file downloading procedure in a closed environment through executing the pre-stored event script. Because the file downloading procedure is performed in the closed environment, it is unnecessary for the RPA software to consider whether the network is abnormal. As a result, in the embodiment of FIG. 3A and FIG. 3B, the RPA software may only utilize one origin image 41 to perform the comparison, wherein the content of the origin image 41 indicates the image of file download completed.

In the embodiment of FIG. 6A, FIG. 6B, and FIG. 6C, the RPA software implements the file downloading procedure through website via executing the pre-stored event script. Because the file downloading procedure is performed through website, the RPA software needs to determine whether the network connection is normal or not addition to determining whether the file is downloaded completely, so as to avoid meaningless waiting while the network is already malfunction. As a result, in the embodiment of FIG. 6A, FIG. 6B, and FIG. 6C, the RPA software needs to utilize at least two origin images (i.e., the first origin image 51 and the second origin image 52) to perform the comparison, wherein the content of the first origin image 51 is the image indicating a normal network connection (such as the blank image) and the content of the second origin image 52 is the image indicating that the file is downloaded completely (such as indicating the storing position of the file being completely downloaded).

Addition to the file downloading procedure, the RPA software may also implement another procedure through executing the pre-stored event script. For example, the procedure may be a procedure of waiting for a login request raised remotely.

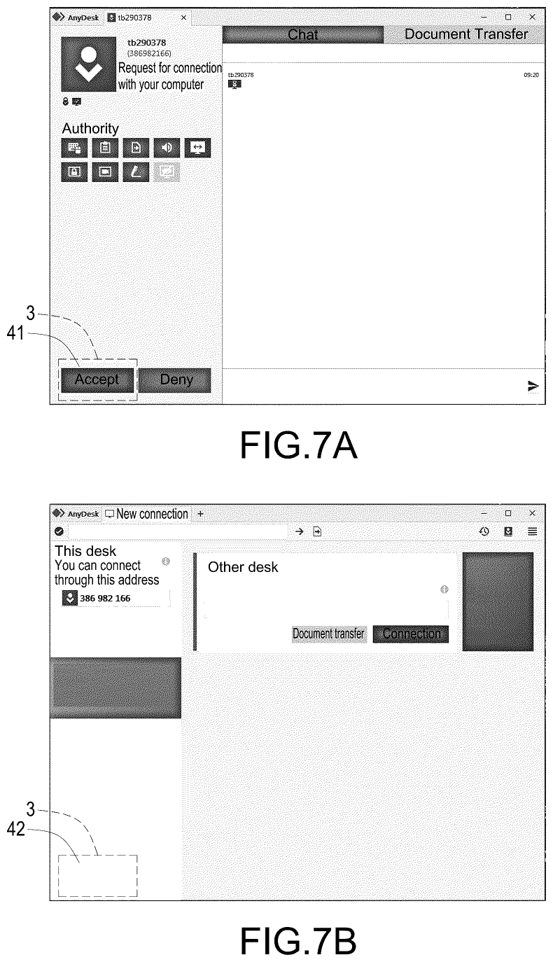

Please refer to FIG. 7A and FIG. 7B, wherein FIG. 7A is a schematic diagram showing an origin image of a third embodiment according to the present disclosure and FIG. 7B is a schematic diagram showing a current status image of a third embodiment according to the present disclosure. In the embodiment, the user needs to first capture the target image of the specific geographic range 3 on the displaying screen to generate the origin image 41 when the procedure is executed completely (i.e., receives the login request raised remotely). As shown in FIG. 7A, the target image is the image prompting the login request raised remotely.

When performing the method of the present disclosure, the OS first launches the remote desktop software and then launches the RPA software. After the RPA software is initiated, the pre-stored event script can be executed (i.e., the event script corresponding to the procedure of waiting for the login request raised remotely), and continuously captures the screenshot of the geographic range 3 on the displaying screen to generate the current status image 42 while waiting. As shown in FIG. 7B, because the current status image 42 is unmatched with the origin image 41, the RPA software may determine that the login request raised remotely is not yet received. In this case, the RPA software re-captures the screenshot of the geographic range 3 to generate a new current status image 42 and re-compares the new current status image 42 with the origin image 41 until the new current status image 42 is determined to be matched with the origin image 41.

As shown in FIG. 2, after determining that the current status image and the origin image is matched, the RPA software may proceed to execute the next step. In the embodiment of waiting for the login request raised remotely, the RPA software may control the HMI of the OS to move the tracing (such as the mouse cursor) to the geographic range 3 to trigger a button that permits the login request after determining that the current status image is matched with the origin image (i.e., after receiving the login request raised remotely). Therefore, the RPA software may be utilized to perform a remote automatic login activity, which is very convenient.

The present disclosure utilizes images to assist the RPA software to confirm the event status, so that the integrity and the reliability of automated processes can be ensured and the chance of execution failures can be reduced. Besides, when applying the automation of the file downloading procedure, the present disclosure may check the file download failures or incomplete downloads in real-time so that appropriate actions can be taken immediately. Therefore, the present disclosure may save both time and resource and void the additional time required to deal with the incomplete files or failed files.

What is claimed is:

1. A method for confirming event status in robotic process automation through images, applied in an operation system (OS), comprising:
step a) initiating a robotic process automation (RPA) software in the OS;
step b) executing a pre-recorded event script by the RPA software;
step c) obtaining a pre-stored origin image associated with the event script, wherein the origin image comprises a target image of a specific geographic range on a displaying screen of the OS;
step d) automatically capturing a screenshot of the geographic range to obtain a current status image by the RPA software;
step e) comparing the current status image with the origin image;
step f) capturing a screenshot of the geographic range again to obtain another current status image and re-executing the step e) when the current status image is determined to be unmatched with the origin image; and
step g) executing a next step of the event script by the RPA software when the current status image is determined to be matched with the origin image.

2. The method in claim 1, wherein the step e) further comprises:
step e11) respectively performing a binarization operation to the current status image and the origin image;
step e12) respectively executing a pixel comparison algorithm to the current status image and the origin image after the binarization operation to respectively obtain effective pixels of the current status image and effective pixels of the origin image; and
step e13) computing a similarity proportion of the current status image and the origin image based on the effective pixels of the current status image and the effective pixels of the origin image and determining whether the current status image is matched with the origin image in accordance with the similarity proportion.

3. The method in claim 2, wherein the step e13) further comprises:
step e131) dividing the effective pixels of the current status image by the effective pixels of the origin to obtain a calculation result and multiplying the calculation result by 100% to obtain the similarity proportion;
step e132) determining that the current status image is matched with the origin image if the similarity proportion is greater than or equal to a threshold; and
step e133) determining that the current status image is unmatched with the origin image if the similarity proportion is smaller than the threshold.

4. The method in claim 1, wherein the target image indicates a specific status of a procedure corresponding to the event script, and the geographic range is a displaying position that the specific status being shown on the displaying screen.

5. The method in claim 1, wherein the step c) comprises obtaining a first origin image and a second origin image associated with the event script, wherein the first origin image comprises a first target image of a first geographic range on the displaying screen, the second origin image comprises a second target image of a second geographic range on the displaying screen, and the second geographic range is different from the first geographic range;
wherein, the step d) comprises automatically capturing a first current status image from the first geographic range and capturing a second current status image from the second geographic range.

6. The method in claim 5, wherein the step e) comprises:
step e21) comparing the first current status image with the first origin image that are corresponding to the first geographic range;
step e22) further comparing the second current status image with the second origin image that are corresponding to the second geographic range if the first current status image is determined to be matched with the first origin image;
step e23) executing the step f) if the second current status image is determined to be unmatched with the second origin image; and
step e24) executing the step g) if the second current status image is determined to be matched with the second origin image.

7. The method in claim 6, wherein the step e) further comprises:
step e25) determining that an error occurs while the execution of the event script if the first current status image is determined to be unmatched with the first origin image; and
step e26) issuing an alarming message after the step e25).

8. The method in claim 1, further comprising following steps before the step a):
step a01) initiating the RPA software in the OS;
step a02) accepting an operation through a human-machine interface by the OS;
step a03) recording a tracing coordinate of the human-machine interface and an event being triggered by the human-machine interface to be the event script by the RPA software; and
step a04) setting a script schedule of the event script;
wherein the step b) comprises automatically executing the event script by the RPA software based on the script schedule.

9. The method in claim 1, wherein the event script is executed to implement a file downloading procedure under a closed system, and the target image is an image indicating that a file is downloaded completely.

10. The method in claim 1, wherein the step a) comprises opening a remote desktop software before initiating the RPA software, the event script is executed to wait for a login request raised remotely, the target image is an image indicating the login request, and the step g) comprises controlling a human-machine interface to move a trace to the geographic range to trigger a button for permitting the login request by the RPA software.

11. The method in claim 5, wherein the step a) is executed to implement a file downloading procedure through website, the first target image is an image indicating a normal network connection, and the second target image is an image indicating that a file is downloaded completely.
